(19) United States
(12) Patent Application Publication
(10) Pub. No.: US 2023/0145310 A1
(43) Pub. Date: May 11, 2023

(54) RECYCLED LEATHER PRODUCT AND ITS METHOD OF MANUFACTURE

(71) Applicant: RE-LEATHER SRL, 50018 SCANDICCI (FI) (IT)

(72) Inventor: LUCA QUERCI, SIGNA (IT)

(21) Appl. No.: 17/907,498

(22) PCT Filed: Apr. 2, 2021
(86) PCT No.: PCT/IB2021/052763

§ 371 Date: Sep. 27, 2022

(30) Foreign Application Priority Data
Apr. 2, 2020 (IT) 102020000006949

(51) Int. Cl. C14B 7/04

(52) U.S. Cl. CPC C14B 7/04; C14B 2700/11

(57) ABSTRACT

Described is a recycled leather product comprising, on a supporting layer, a thickness which has a mixture of ground leather fibres and powdered resins and/or heat-sensitive fibres. The invention also relates to a method for making the recycled leather product which comprises the following steps: – selecting and collecting waste from the processing of leather, substantially trimmings and swarf of finished leather coming from the steps for cutting leather goods and footwear, in such a way as to obtain a collected material; – crushing the material collected into pieces of controlled size, preferably with dimensions substantially equal to 10 mm, and mixing/homogenizing the pieces of controlled size, in such a way as to obtain granulated material; – grinding the granulated material for reducing it into leather fibrils, preferably having a size of between 0.5 and 1 mm, inclusive; – mixing the fibrils with powdered resins and/or heat-sensitive fibres and placing them in an orderly fashion on a supporting layer which has at least one adhesive surface portion, in such a way as to make a formed material; – consolidating the formed material by heat setting and compression; – cutting and rolling the consolidated material which is heat-set and compressed; – finishing the rolled material thus obtained to obtain a finished leather product.

### DESCRIPTION

### Technical Field

This invention relates to a recycled leather product and to a relative method of making the product.

### Background Art

According to the prior art, the production of a product or fabric with recycled leather involves the re-use of leather waste from the tanning process using chromate salts, that is to say, leather at an intermediate processing stage (known as “wet blue”), which often has a fibre format and does not require very intense mechanical granulation actions, determining an average length of the leather fibres of a few millimetres.

A first drawback of these manufacturing methods is due to the fact that many waste leathers cannot be reused. More specifically, all those falling within a predetermined type having a morphological structure marked by the heavy chemical processes occurring in the previous processing operations cannot be used by means of the prior art processes.

Moreover, the prior art methods for making recycled leather products have a high environmental impact as they are moist processes derived from processes normally used for the production of paper; or they use special consolidation processes using water. In both cases, it is necessary to control problems relative to the treatment of the waste water using considerable amounts of energy.

These prior art methods also have a significant economic impact, due both to the technological complexity and the length of the process.

In addition, as is known from patent document US2014113520(A1), the recycled leather products according to the prior art have a layer of leather reconstituted from a mixture of basic fibres, such as leather fibres and bicomponent synthetic fibres which have outer layers which dissolve at a temperature less than their inner cores. The fibres are mixed, formed in a second mesh and heated in such a way that the synthetic fibres are melted together to form a second mesh inside the first mesh. The basic fibres are then kinked, whilst they are constrained by the mesh, using the water punching process, which penetrates the leather fibres in the support. However, this method requires a costly system and requires a certain length of fibre in order to be effective, not less than one millimetre.

### Aims and Summary of the Invention

The purpose of the invention is to overcome the above-mentioned drawbacks of prior art recycled leather products, improving the quality and duration of the fabric, of the garment, of the item of footwear or of the accessory in which the product is present.

In the context of the above-mentioned purpose, an aim of the invention is to make a recycled leather product with any type of waste, irrespective of the size, origin or type.

Another aim of the method for making a recycled leather product is to have a lowest possible environmental impact, improving the environmental compatibility of the prior art methods.

Yet another aim of the invention is to make a recycled leather product with a method which is economically sustainable, in such a way as to obtain a competitive product.

### BRIEF DESCRIPTION OF THE INVENTION

This purpose, as well as these and other aims which will become clearer below, are achieved by recycled leather product and a method of making it, according to the invention, comprising the technical features described in the appended claims.

### DETAILED DESCRIPTION OF THE ACTUATION OF INVENTION

Further features and advantages of the invention will become more apparent in the detailed description below, with reference to a preferred, non-limiting embodiment of the recycled leather product, according to the invention, which comprises, on a supporting layer, a thickness which has a mixture of recycled ground leather fibres and resins in powder form and/or heat-sensitive fibres.

In the preferred embodiment, the thickness has a mixture of recycled leather fibres and powdered resins.

Advantageously, so as to obtain a product with improved strength, the supporting layer is a woven or a non-woven fabric.

Advantageously, in order to obtain a product of a higher quality, the ground recycled leather fibres have an average size of between 0.5 and 1 mm, inclusive.

The method for making the recycled leather product described above comprises the following steps:
selecting and collecting waste from the processing of leather, substantially trimmings and swarf of finished leather coming from the steps for cutting leather goods and footwear, in such a way as to obtain a collected material;
crushing the material collected into pieces of controlled size, preferably with dimensions substantially equal to 10 mm, and mixing/homogenizing said pieces of controlled size, in such a way as to obtain homogeneous granulated material;
grinding the granulated material for reducing it into leather fibrils, preferably having a size of between 0.5 and 1 mm, inclusive;
mixing the fibrils with powdered resins and/or heat-sensitive fibres and placing them in an orderly fashion on a supporting layer which has at least one adhesive surface portion, in such a way as to make a formed material;
consolidating the formed material by heat setting and compression;
cutting and rolling the consolidated material which is heat-set and compressed;
finishing the rolled material thus obtained to obtain a finished leather product.

The term “finished leather” is used to mean any type of hide (cow, sheep, pig, etc.), full grain, corrected grain and split, etc.

These leathers may be tanned with all the tanning methods, by way of example (but not exclusively): chromate salts, vegetable, synthetic, zirconium, aldehydes, etc., and then fibre-coloured.

The term “finished leather” is used to mean leather treated during finishing with dyes and polymers (of various types) which constitute surface films with different thicknesses and colours.

The term “finished leather” is used to also mean suede leather, velour, crust and nubuck.

Advantageously, the collection and the (pre)selection by colour and type of waste of the processing of leather, with particular reference to the trimmings of finished leather coming from leather goods and footwear, which is waste that, in any case, would be scrapped, on the one hand allows a recycling operation which certainly has a positive impact on the environment and, on the other hand, also gives the waste a noninsignificant economic value, generating a circular economy for the waste. In fact, the hides treated in the method according to the invention are finished, that is to say, it is waste coming from the cutting and packaging steps of, for example, calf, goat or lamb hide, which has undergone the entire tanning and finishing process.

Advantageously, the first processing to which the waste of finished leather is subjected is performed by a granulator device which reduces the waste to a format of approximately 10 mm, which is uniform and homogeneous. This step is combined with a step of mixing the granulated material in order to homogenize the various types of waste processed and to feed to the subsequent step of the process a quality of material constant over time. In this way, the mixing and homogenizing of leather waste entering the process is allowed, which is particularly suitable because the leather waste used in this recycling method is not homogeneous since it does not arrive from the tanning process.

Preferably, the granulated material is stored in mixing containers, in such a way as to homogenize it and then pass it to the subsequent crushing step. Advantageously, the second processing is performed in a fine granulator which reduces the granulate of approximately 10 mm. into fibrils with a size of between 0.5 and 1 mm. For this purpose, the granular waste, previously reduced to dimensions of approximately 10 mm, is introduced into suitable high-speed blades mills by a conveyor belt. The reduced size of the fibrils allows a more intimate bond and a higher content of recycled leather (and a smaller quantity of binder) in the product made in this way. In addition, such a small size of fibrils gives the surface of the recycled product a compact appearance.

Preferably, the fibrils at the outfeed are sucked by a fan and collected by a suitable separator cyclone in containers provided, for example, large bags. In a first embodiment, the leather fibrils are fed to a series of feeding machines positioned one parallel to another. The leather fibrils obtained can therefore be fed to a series of feeding machines positioned parallel to each other. Each of the feeding machines is equipped with a weighing system which allows the quantity of each component fed to the process to be automatically controlled, in such a way as to mix in a controlled manner different qualities of leather waste fed to the process and allow mixing with heat-sensitive fibres; the leather fibrils, mixed in this way, are then conveyed pneumatically (in a pipe through a fan) towards forming means, for example a forming machine.

In one variant, the leather fibrils are fed directly to forming means pneumatically or by means of a conveyor belt. In practice, the fibrils are passed to a forming machine which mixes them with powdered resins and places them in an orderly fashion on a woven or non-woven supporting fabric, on which an adhesive surface was previously prepared. In this passage, with the pipe or on the conveyor belt, chemical substances are preferably added by spraying, aimed at preventing electrostatic charges from forming on the fibrils and facilitating their separation during the subsequent step of forming the product.

This processing allows the separation of lumps of recycled leather fibre which often form by agglomeration, so as to guarantee a perfect distribution of the individual fibres in the finished product. Advantageously, the leather fibrils mixed with the powdered resins are arranged in an orderly fashion to form a sheet-like element with a controlled weight and thickness so as to obtain the formed material. Preferably, the powdered resins mainly used are polyurethane or polyamide-based resins, with the function of adhesive in the subsequent heat setting and compression step.

During the forming step a woven or non-woven fabric is advantageously introduced to make the supporting layer so as to deposit the fibres on it: the material performs the function of transporting the material during the process and reinforcing the finished product, since it gives mechanical properties of tensile strength, resistance to tearing etc. The support obviously has an adhesive side, previously made with heat-adhesive in dots to guarantee perfect adhesion to the fibrils.

The possibility of introducing powdered resins into the forming chamber of the forming machine, where they are perfectly mixed with the leather fibres before depositing on the belt, together with the action of distributor cylinders positioned in the forming chamber, guarantees a perfect resin/fibre mixing, reducing to a minimum the maintenance and cleaning operations of the machine.

Advantageously, the heat setting is achieved by using a hot air oven combined with a high pressure cold bending machine for consolidating the material feeding out of the forming machine. The oven activates the resin mixed with the leather fibrils, which facilitates the mutual cohesion and the cohesion between the fibrils and the supporting layer, if any. The pressure stabilizes the material and brings it to the desired density and thickness, contributing to reinforcing the resin/fibril links created.

Preferably, after the cold bending, at the outlet from the hot air oven, there is a further bending, this time hot, accompanied by a compression by means of a high pressure action.

Normally, during the cutting and rolling step, the product formed by heat setting and compressed is cut both longitudinally and transversely, in such a way as to be able to package it in rolls.

Advantageously, after the cutting and rolling, the roll of material is impregnated with a resin-based formulation and then dried. This step is an out-of-line finishing treatment which comprises the application of special resins and fixing agents.

Preferably, the application of the resin-based formulation comprises a treatment by immersion of the material which has come out from the forming machine, consisting of polymeric resins and fixing agents in aqueous dispersion. This formulation is made using a mixture of polymers in an aqueous phase with characteristics of elasticity, flexibility and resistance to abrasion, in order to compact the product, increasing the mechanical properties and the flexibility. This application is performed in a machine comprising an immersion and pressing system with cylinders and subsequent drying and fixing.

Lastly, there are treatments of per se known type, such as smoothing, drumming/perching and any other types of finishing and colouring using direct or transfer finishing or spreading systems, etc.

From the above description, it can be seen how the invention achieves the preset purpose and aims and in particular it should be noted that fabrics, garments, footwear and accessories are made from recycled leather which, thanks to the use of small-sized leather waste, smaller than a millimetre, have better mechanical properties than those of prior art recycled leather fabrics, especially in terms of softness and strength.

Moreover, the making of a thickness with pieces with a grain size of less than one millimetre allows a high quality product to be obtained which has properties similar to new leather.

Another advantage of the method for making a recycled leather product according to the invention is due to the fact that the use of any type of waste, regardless of the size, origin or type, allows a product to be obtained which is compatible with the increasingly desired attention to the environment by consumers and increases the value of pieces of leather which would otherwise have been destined for scrap.

Lastly, the fact that this recycled leather product is made with an economically sustainable method allows the production and marketing of a highly competitive product.

The invention can be modified and adapted in several ways without thereby departing from the scope of the inventive concept.

Moreover, all the details of the invention may be substituted by other technically equivalent elements.

In practice, the materials used, as well as the dimensions, may be of any type, depending on requirements, provided that they are consistent with their production purposes.

1. A recycled leather product comprising, on a supporting layer, a thickness having a mixture of ground leather fibres and powdered resins and/or heat-sensitive fibres.

2. The product according to claim 1, wherein said supporting layer is a woven or a non-woven fabric.

3. The product according to claim 1, wherein said ground leather fibres have an average dimension of between 0.5 and 1 mm, inclusive.

4. A method for making a recycled leather product comprising the following steps:
selecting and collecting waste from the processing of leather, substantially trimmings and swarf of finished leather coming from the steps for cutting leather goods and footwear, in such a way as to obtain a collected material;
crushing the material collected into pieces of controlled size, preferably with dimensions substantially equal to 10 mm, and mixing/homogenizing said pieces of controlled size, in such a way as to obtain granulated material;
grinding the granulated material for reducing it into leather fibrils, preferably having a size of between 0.5 and 1 mm, inclusive;
mixing said fibrils with powdered resins and/or heat-sensitive fibres and placing them in an orderly fashion on a supporting layer comprising at least one adhesive surface portion, in such a way as to make a formed material;
consolidating the formed material by heat setting and compression;
cutting and rolling the consolidated material which is heat-set and compressed;
finishing the rolled material thus obtained to obtain a finished leather product.

5. The method according to claim 4, comprising the step of storing the granulated material in at least one mixing container, in such a way as to homogenize it.

6. The method according to claim 4, wherein said leather fibrils are fed to a series of feeding machines positioned one parallel with another, each of said feeding machines being equipped with a weighing system which allows the quantity of each component fed to the process to be automatically controlled, in such a way as to mix in a controlled manner different qualities of leather waste fed to the process; said leather fibrils, mixed in this way, are then transported pneumatically towards forming means.

7. The method according to claim 4, wherein said leather fibrils are fed directly to forming means by pneumatic means or by means of a conveyor belt.

8. The method according to claim 6, comprising the step of depositing, preferably by spraying, chemical substances on said leather fibrils, in such a way as to avoid the formation of electrostatic charges on them as well as to facilitate the separation of the leather fibrils in the subsequent step of forming the product.

9. The method according to claim 4, comprising the step of placing said leather fibrils in an ordered fashion to form a sheet-like element with a controlled weight and thickness so as to obtain the formed material, leather fibrils being mixed with resins in powder form.

10. The method according to claim 9, wherein said powdered resins are polyurethane or polyamide-based resins, with the function of an adhesive in the subsequent heat setting and compression step.

11. The method according to claim 4, wherein during the forming a woven or non-woven fabric is introduced for making said supporting layer, having at least one adhesive surface portion, for depositing said leather fibrils in such a way as to facilitate the transport of the material during the steps of processing and strengthening the finished product.

12. The method according to claim 4, wherein said heat setting is achieved by using a hot air oven combined with a high pressure cold bending machine.

13. The method according to claim 4, comprising the step of impregnating the rolled material with a resin-based formulation and then drying it.

14. The method according to claim 13, wherein the application of said resin-based formulation comprises a treatment for immersion of the formed material in polymeric resins and fixing agents in an aqueous dispersion, said resin-based formulation being made using a mixture of polymers in an aqueous phase with characteristics of elasticity, flexibility and resistance to abrasion, in order to compact the product, increasing the mechanical properties and the flexibility.
